(19) United States
(12) Patent Application Publication
(10) Pub. No.: US 2021/0288311 A1
(43) Pub. Date: Sep. 16, 2021

(54) POSITIVE ELECTRODE FOR NON-AQUEOUS ELECTROLYTE SECONDARY BATTERIES

(71) Applicant: Panasonic Intellectual Property Management Co., Ltd., Osaka-shi, Osaka (JP)

(72) Inventors: Takashi Ko, Hyogo (JP); Fumiharu Niina, Hyogo (JP); Katsunori Yanagida, Hyogo (JP)

(73) Assignee: Panasonic Intellectual Property Management Co., Ltd., Osaka-shi, Osaka (JP)

(21) Appl. No.: 16/326,507

(22) PCT Filed: Sep. 15, 2017
(86) PCT No.: PCT/JP2017/033384

§ 371 Date: Feb. 19, 2019

(30) Foreign Application Priority Data
Sep. 30, 2016 (JP) 2016-193863

(51) Int. Cl. H01M 4/36; H01M 4/525; H01M 4/505; H01M 4/485; H01M 10/0525

(52) U.S. Cl. CPC H01M 4/364; H01M 4/525; H01M 2004/028; H01M 4/485; H01M 10/0525; H01M 4/505

(57) ABSTRACT

A positive electrode for nonaqueous electrolyte secondary batteries which contains a first positive electrode active material, a second positive electrode active material and a phosphoric acid compound. With respect to the first positive electrode active material, the volume per mass of pores having a pore diameter of 100 nm or less is 8 mm³/g or more. With respect to the second positive electrode active material, the volume per mass of pores having a pore diameter of 100 nm or less is 5 mm³/g or less. In addition, the volume per mass of pores having a pore diameter of 100 nm or less of the first positive electrode active material is four times or more the volume per mass of pores having a pore diameter of 100 nm or less of the second positive electrode active material.

### TECHNICAL FIELD

The present disclosure relates to a positive electrode for a non-aqueous electrolyte secondary battery.

### BACKGROUND ART

On mobile digital assistants such as mobile phones, laptop computers, and smartphones, reduction in size and weight has been rapidly progressing in recent years, and a larger capacity is demanded of their secondary batteries as a power source for driving. A non-aqueous electrolyte secondary battery, which achieves charge and discharge by movement of lithium ions between positive and negative electrodes, has a high energy density and a large capacity, and is thus used widely as a power source for driving mobile digital assistants.

More recently, a non-aqueous electrolyte secondary battery has attracted attention as a power source for engines of electric tools, electric vehicles (EV), hybrid electric vehicles (HEV, PHEV), and the like, and thus wider spread use thereof is expected. Of such power sources for engines, demanded is a large capacity that enables long time use and improvement in output characteristics when high current charge and discharge are carried out repeatedly in a relatively short time. Thus, it is necessary to provide a large capacity while maintaining output characteristics upon high current charge and discharge.

Patent Literature 1 discloses a positive electrode active material for a non-aqueous electrolyte secondary battery, comprising a porous particle made of a lithium composite oxide comprising as main components one or more elements selected from the group consisting of Co, Ni, and Mn, and lithium, the particle having average pore diameter within a range of 0.1 to 1 μm in analysis of pore size distribution according to mercury porosimetry and a total volume of pores having a diameter of 0.01 to 1 μm of 0.01 cm³/g or more, and also discloses a positive electrode for a non-aqueous electrolyte secondary battery using this positive electrode active material. Patent Literature 1 purports that the positive electrode active material and the positive electrode can improve loading characteristics of batteries without impairing fillability of the active material in the positive electrode.

### CITATION LIST

### Patent Literature

PATENT LITERATURE 1: Japanese Patent Laid-Open Publication No. 2000-323123

### SUMMARY

### Technical Problem

However, the conventional technique described above may provide insufficient high-rate cyclic characteristics of a non-aqueous electrolyte secondary battery.

An object of the present disclosure is to provide a positive electrode for a non-aqueous electrolyte secondary battery that can improve high-rate cyclic characteristics of a non-aqueous electrolyte secondary battery.

### Solution to Problem

A positive electrode for a non-aqueous electrolyte secondary battery of one aspect of the present disclosure comprises a first positive electrode active material, a second positive electrode active material, and a phosphate compound. The first positive electrode active material has a pore volume, of pores each having a pore diameter of 100 nm or less, per mass of 8 mm³/g or more. The second positive electrode active material has a pore volume, of pores having a pore diameter of 100 nm or less, per mass of 5 mm³/g or less. The pore volume, of pores each having a pore diameter of 100 nm or less, per mass of the first positive electrode active material is 4 or more times the pore volume, of pores each having a pore diameter of 100 nm or less, per mass of the second positive electrode active material.

### Advantageous Effect of Invention

According to the positive electrode for a non-aqueous electrolyte secondary battery of one aspect of the present disclosure, high-rate cyclic characteristics of a non-aqueous electrolyte secondary battery is improved.

### BRIEF DESCRIPTION OF DRAWING

FIG. 1 is a sectional view of a non-aqueous electrolyte secondary battery as an exemplary embodiment.

### DESCRIPTION OF EMBODIMENTS

As a result of earnest studies, the inventors of the present application have found that when a positive electrode for a non-aqueous electrolyte secondary battery comprises a first positive electrode active material and a second positive electrode active material each having a specific pore volume, of pores each having a pore diameter of 100 nm or less, per mass, and also comprises a phosphate compound, high-rate cyclic characteristics of a resulting non-aqueous electrolyte secondary battery can be improved.

Exemplary embodiments will now be described in detail with reference to a drawing. The positive electrode and the non-aqueous electrolyte secondary battery of the present disclosure are not limited to the embodiments described below. A cylindrical battery in which a cylindrical battery case houses an electrode assembly with a wound structure is illustrated below as an exemplary embodiment. However, the structure of the electrode assembly is not limited to the wound structure, and may be a laminated structure formed by alternately laminating a plurality of positive electrodes and a plurality of negative electrodes with separators therebetween. Moreover, the battery case is not limited to a cylindrical shape, and may be a metal case having a rectangular shape (for rectangular batteries) or a coin shape (for coin cells), or a resin case constituted of resin films (for laminate batteries), for example. The drawing referred for the description of embodiments is schematically illustrated, and the dimensions and the like of the components should be determined in consideration of the description below.

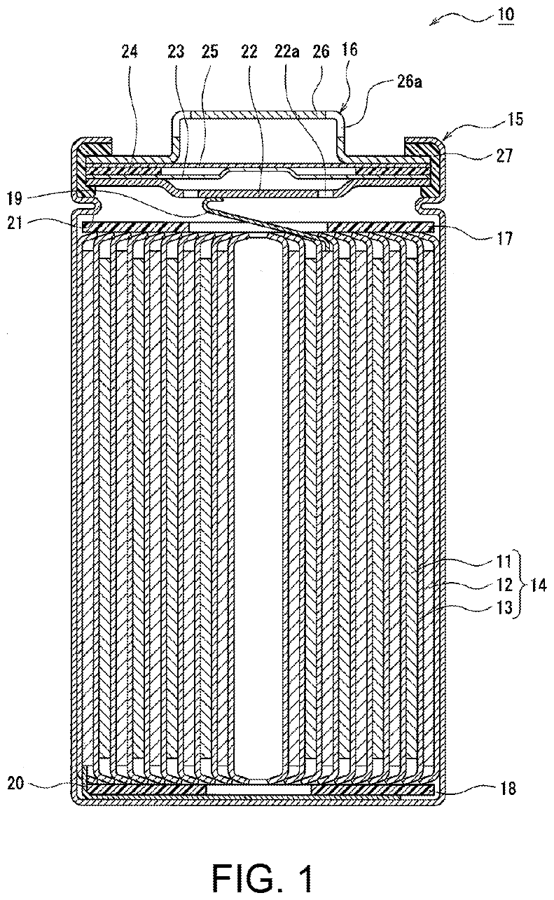

FIG. 1 is a sectional view of a non-aqueous electrolyte secondary battery 10 as an exemplary embodiment. As illustrated in FIG. 1, the non-aqueous electrolyte secondary battery 10 includes an electrode assembly 14, a non-aqueous electrolyte (not shown), and a battery case that houses the electrode assembly 14 and the non-aqueous electrolyte. The electrode assembly 14 has a wound structure in which a positive electrode 11 and a negative electrode 12 are wound together with a separator 13 therebetween. The battery case is constituted of a closed-end cylindrical case body 15 and a sealing assembly 16 that blocks the opening of the body.

The non-aqueous electrolyte secondary battery 10 includes insulating plates 17 and 18 respectively disposed on the upper and lower sides of the electrode assembly 14. In the example shown in FIG. 1, a positive electrode lead 19 attached to the positive electrode 11 passes through a through-hole in the insulating plate 17 and extends toward the sealing assembly 16, and a negative electrode lead 20 attached to the negative electrode 12 extends on the outside of the insulating plate 18 to the bottom side of the case body 15. The positive electrode lead 19 is connected to the lower surface of a filter 22, which is the bottom board of the sealing assembly 16, by welding or the like, and a cap 26, which is the top board of the sealing assembly 16, electrically connected to the filter 22 serves as a positive terminal. The negative electrode lead 20 is connected to the inner surface of the bottom of the case body 15 by welding or the like, and the case body 15 serves as a negative terminal.

The case body 15 is, for example, a closed-end cylindrical metal container. A gasket 27 is disposed between the case body 15 and the sealing assembly 16 to ensure that the battery case is tightly sealed. The case body 15 includes a projecting portion 21 formed by, for example, pressing the lateral surface from outside to support the sealing assembly 16. The projecting portion 21 is preferably formed annularly along the circumferential direction of the case body 15, and the upper surface of the projecting portion 21 supports the sealing assembly 16.

The sealing assembly 16 includes the filter 22 and a vent member disposed thereon. The vent member blocks the opening 22a of the filter 22, and ruptures if the internal pressure of the non-aqueous electrolyte secondary battery 10 increases due to heating by internal short-circuit, for example. In the example shown in FIG. 1, a lower vent member 23 and an upper vent member 25 are provided as vent members, and an insulating member 24 is provided between the lower vent member 23 and the upper vent member 25. Each of the members constituting the sealing assembly 16 has, for example, a disk or ring shape, and the members other than the insulating member 24 are electrically connected to each other. The lower vent member 23 ruptures at, for example, the thin portion thereof if the internal pressure of the non-aqueous electrolyte secondary battery 10 highly increases. The upper vent member 25 thus bulges toward the cap 26 and comes off the lower vent member 23, thereby breaking the electrical connection between the valves. If the internal pressure further increases, the upper vent member 25 ruptures, and gas is discharged from the opening 26a of the cap 26.

Each of the components, particularly the positive electrode 11, of the non-aqueous electrolyte secondary battery 10 will be described in detail below.

### <Positive Electrode>

The positive electrode 11 for a non-aqueous electrolyte secondary battery (positive electrode 11) includes, for example, a positive collector such as metal foil and a positive electrode active material layer formed on the positive collector. Foil of a metal, such as aluminum, that is stable in the electric potential range of the positive electrode 11, a film with such a metal disposed as an outer layer, and the like can be used for the positive collector. The positive electrode mixture layer contains the positive electrode active material, an electrical conductor, and a binder. The positive electrode 11 can be produced by, for example, applying a positive electrode mixture slurry containing the positive electrode active material, the electrical conductor, the binder, and other components to the positive collector, drying the resulting coating film, and rolling the resulting product to form a positive electrode mixture layer on each side of the collector.

Examples of the electrical conductor include carbon materials such as carbon black, acetylene black, Ketjenblack, and graphite. These may be used singly or in combinations of two or more thereof.

Examples of the binder include fluoro resins, such as polytetrafluoroethylene (PTFE) and poly(vinylidene fluoride) (PVdF), polyacrylonitrile (PAN), polyimides, acrylic resins, and polyolefins. These resins may be combined with carboxymethyl cellulose (CMC) or a salt thereof, poly(ethylene oxide) (PEO), or the like. These may be used singly or in combinations of two or more thereof.

The positive electrode 11 comprises a first positive electrode active material, a second positive electrode active material, and a phosphate compound. The first positive electrode active material has a pore volume, of pores each having a pore diameter of 100 nm or less, per mass of 8 mm³/g or more, and the second positive electrode active material has a pore volume, of pores having a pore diameter of 100 nm or less, per mass of 5 mm³/g or less. The ratio of the pore volume, of pores each having a pore diameter of 100 nm or less, per mass of the first positive electrode active material to the pore volume, of pores each having a pore diameter of 100 nm or less, per mass of the second positive electrode active material is 4 or more.

Hereinafter, “a pore volume, of pores each having a pore diameter of 100 nm or less, per mass” of a positive electrode active material is also referred to as a “100 nm or less pores volume”, and “the ratio of the pore volume, of pores each having a pore diameter of 100 nm or less, per mass of the first positive electrode active material to the pore volume, of pores each having a pore diameter of 100 nm or less, per mass of the second positive electrode active material” is also referred to as “the first/second pore volume ratio”.

The 100 nm or less pores volume of a positive electrode active material can be measured according to a known method. For example, a pore distribution curve is prepared according to the BJH method from measurement results of the amount of nitrogen adsorbed on a positive electrode active material with respect to the nitrogen gas pressure as determined according to the nitrogen adsorption method, and the total volume of pores having a pore diameter within a range of 100 nm or less is determined by summing up the volumes of 100 nm or less pores of the positive electrode active material. The BJH method is a method in which a pore volume corresponding to a pore diameter is calculated using a pore model having a cylindrical shape to determine a pore distribution. The pore distribution according to the BJH method can be determined using, for example, a device for measuring an amount of a gas adsorbed (manufactured by Quantachrome Corporation).

Both the first positive electrode active material and the second positive electrode active material, which are each contained as a positive electrode active material in the positive electrode mixture layer, are lithium-containing transition metal oxide. The lithium-containing transition metal oxide is a metal oxide containing at least lithium (Li) and a transition metal element. The lithium-containing transition metal oxide may contain an additional element other than lithium (Li) and the transition metal element.

The mechanism for improving high-rate cyclic characteristics of the non-aqueous electrolyte secondary battery 10 by the positive electrode 11 can be considered as follows. When there are pores having a pore diameter of 100 nm or less in the positive electrode active material, the effective reaction area increases and also the diffusion length of a Li ion in solid can be significantly decreased, in the positive electrode active material. Thus, the high-rate characteristics of the battery can be improved. Since the positive electrode according to the present embodiment includes the first positive electrode active material having a 100 nm or less pores volume of 8 mm³/g or more, the charging reaction is considered to occur predominantly in the first positive electrode active material when charging the battery, and the first positive electrode active material is thus considered to result in a more highly oxidized state than the second positive electrode active material to thereby have a higher reaction activity.

At this time, if the phosphate compound that is present in the vicinity is brought into contact with the first positive electrode active material in a highly oxidized state, the phosphate compound partially undergoes oxidative decomposition. The oxidatively decomposed product of the phosphate compound is diffused onto and adheres to the surrounding positive electrode active material and forms a film thereon. It is considered that the film can inhibit side reactions in charging, such as oxidative decomposition of the electrolyte solution and dissolution of metals, to thereby improve high-rate cyclic characteristics of the non-aqueous electrolyte secondary battery 10, more specifically, the output retention rate at normal temperature after a high-rate cycle test. “Normal temperature” herein means, for example, 25° C.

As mentioned above, the charging reaction is likely to occur when the positive electrode active material has the pores having a pore diameter of 100 nm or less. If the positive electrode active material includes only the first positive electrode active material having a 100 nm or less pores volume of 8 mm³/g or more, it is difficult that the charging reaction occurs predominantly in a part of the positive electrode active material in the positive electrode mixture layer. That is, a uniform charging reaction is likely to occur in the positive electrode mixture layer. Thus, if only the first positive electrode active material is included as the positive electrode active material, the high-rate cyclic characteristics of the non-aqueous electrolyte secondary battery 10 is considered not to be improved because of the following reason: since the amount of a positive electrode active material that becomes highly oxidized state is very small, oxidative decomposition of the phosphate compound and the formation of a film made of the oxidatively decomposed product thereof do not occur, and as a result, the side reactions describe above are not inhibited. Also in the case where the positive electrode active material includes only the second positive electrode active material, the high-rate cyclic characteristics of the non-aqueous electrolyte secondary battery 10 is considered not to be improved because of, for example, the same reasons described above.

The first/second pore volume ratio is 4 or more in the positive electrode 11. If the first/second pore volume ratio is less than 4, which means that the 100 nm or less pores volume of the first positive electrode active material is close to the 100 nm or less pores volume of the second positive electrode active material, it is probably difficult that the charging reaction occurs predominantly in the first positive electrode active material, and therefore, it is also difficult that the first positive electrode active material becomes highly oxidized state.

In the positive electrode 11, the content of the first positive electrode active material is preferably 30 mass % or less based on the total amount of the first positive electrode active material and the second positive electrode active material. This increases the amount per mass of the first positive electrode active material that participates in the reaction, and the first positive electrode active material thus becomes more highly oxidized state than the second positive electrode active material, which even more facilitates the film formation due to oxidative decomposition of the phosphate compound to thereby highly improve the high-rate cyclic characteristics of the non-aqueous electrolyte secondary battery 10. The content of the first positive electrode active material is more preferably 3 mass % or more and 30 mass % or less, even more preferably 5 mass % or more and 30 mass % or less, in view of trade-off between facilitation of the film formation due to oxidative decomposition reaction of the phosphate compound and the uniform film formation in the positive electrode mixture layer.

For example, the upper limit of the 100 nm or less pores volume of the first positive electrode active material is preferably, but not limited to, 100 mm³/g or less, more preferably 50 mm³/g or less. The 100 nm or less pores volume of the first positive electrode active material is preferably, 10 mm³/g or more, more preferably 15 mm³/g or more. The lower limit of the 100 nm or less pores volume of the second positive electrode active material is not limited and 0 mm³/g or more. The 100 nm or less pores volume of the second positive electrode active material is more preferably 3 mm³/g or less, even more preferably 2 mm³/g or less.

For example, the particle diameter of the first positive electrode active material and particle diameter of the second positive electrode active material are each preferably, but not limited to, 2 μm or more and 30 μm or less in terms of the average particle diameter. If the average particle diameter of the first positive electrode active material and the average particle diameter of the second positive electrode active material are each 2 μm or less, the conductive path formed of the conductive material in the positive electrode mixture layer may be impaired to thereby deteriorate the high-rate cyclic characteristics. On the other hand, if the average particle diameter of the first positive electrode active material and the average particle diameter of the second positive electrode active material are each 30 μm or more, the reaction area may decrease to thereby deteriorate the loading characteristics.

The average particle diameter of a positive electrode active material means a volume average particle diameter measured according to laser diffraction method that is a median diameter at which the cumulative volume is 50% in the particle diameter distribution. The average particle diameter of a positive electrode active material can be measured using, for example, a laser diffraction/scattering particle diameter distribution analyzer (manufactured by HORIBA, Ltd).

The first positive electrode active material and the second positive electrode active material are preferably secondary particles, which are formed of agglomerated primary particles. Also in such a case, the first positive electrode active material and the second positive electrode active material each preferably have the average particle diameter described above. More preferably, the average particle diameter of the primary particles constituting the first positive electrode active material is 500 nm or less and smaller than the average particle diameter of the primary particles constituting the second positive electrode active material, when both the first positive electrode active material and the second positive electrode active material are in the form of secondary particles. The reason for this is that such a first positive electrode active material is likely to become highly oxidized state in the charging reaction compared to the second positive electrode active material to more facilitate the film formation due to oxidative decomposition of the phosphate compound to thereby more highly improve the high-rate cyclic characteristics.

The average particle diameter of the primary particles when the positive electrode active material is in the form of secondary particles can be determined as follows, for example: in the observation under a scanning electron microscope (SEM), 100 particles of the positive electrode active material are arbitrarily selected; the average of the lengths of the major axis and the minor axis of each particle is determined as the particle diameter of the each particle; and the average of the particle diameter of the 100 particles is determined as the average particle diameter of the primary particles.

The first positive electrode active material and the second positive electrode active material are each preferably a lamellar lithium transition metal oxide, which has a lamellar crystal structure. Examples thereof include a lamellar lithium transition metal oxide represented by a general formula: L₁₊ₓMₐO_{2+b}, wherein x, a, and b meet the following conditions: a=1, −0.2≤x≤0.4, and −0.1≤b≤0.4, and M represents metal elements including at least one element selected from the group consisting of nickel (Ni), cobalt (Co), manganese (Mn), and aluminum (Al). The lamellar lithium transition metal oxide is likely to become highly oxidized state when a lithium ion is abstracted in the charging reaction, resulting in that oxidative decomposition of lithium phosphate and the film formation described above are likely to occur to thereby remarkably exhibit the effect of improving high-rate cyclic characteristics of the non-aqueous electrolyte secondary battery 10. The lamellar lithium transition metal oxide is particularly preferably lithium nickel cobalt manganese oxide represented by the above general formula and including Ni, Co, and Mn as M.

The composition of the compound used as the positive electrode active material can be determined using an ICP optical emission spectrometer (e.g., product name “iCAP6300”, manufactured by Thermo Fisher Scientific Inc.).

The lamellar lithium transition metal oxide may contain another element in addition to Ni, Co, Mn, and Al, and examples thereof include an alkali metal element other than Li, a transition metal element other than Mn, Ni and Co, an alkaline earth metal element, a group 12 element, a group 13 element other than Al, and a Group 14 element. Specific examples of the other element include zirconium (Zr), boron (B), magnesium (Mg), titanium (Ti), iron (Fe), copper (Cu), zinc (Zn), tin (Sn), sodium (Na), potassium (K), barium (Ba), strontium (Sr), calcium (Ca), tungsten (W), molybdenum (Mo), niobium (Nb) and silicon (Si).

The lamellar lithium transition metal oxide suitably contains Zr. It is considered that when containing Zr, the lamellar lithium transition metal oxide has a stabilized crystal structure to thereby improve durability of the positive electrode mixture layer at a high temperature and cyclic characteristics. The Zr content of the lamellar lithium-containing transition metal oxide is preferably 0.05 mol % or more and 10 mol % or less, more preferably 0.1 mol % or more and 5 mol % or less, particularly preferably 0.2 mol % or more and 3 mol % or less, based on the total amount of metals excluding Li.

The first positive electrode active material and the second positive electrode active material according to the present embodiment can be synthesized in, for example, the following manner: a lithium-containing compound such as lithium hydroxide and an oxide that is obtained by firing a hydroxide containing a metal element other than lithium represented by M in the above general formula are mixed in a intended mixing ratio, and the mixture is fired to thereby obtain secondary particles, which are formed of agglomerated primary particles, of the lamellar lithium transition metal oxide represented by the above general formula. Firing the mixture is carried out in the atmosphere or in an oxygen stream. The firing temperature is about 500 to 1100° C., and the firing time is about 1 to 30 hours when the firing temperature is 500 to 1100° C.

The 100 nm or less pores volume of the lamellar lithium transition metal oxide used as the first positive electrode active material or the second positive electrode active material can be regulated by adjusting parameters when providing the hydroxide containing the metal element M, for example. The hydroxide containing the metal element M can be obtained by, for example, dropping an alkali aqueous solution, such as a sodium hydroxide aqueous solution, into a aqueous solution containing a compound of the metal element M, and stirring the resultant, and at this time, the temperatures of the aqueous solutions, the time duration for dropping the alkali aqueous solution, the stirring rate, pH, and the other conditions are adjusted.

When both the first positive electrode active material and the second positive electrode active material are in the form of secondary particles, the average particle diameter of the primary particles constituting the secondary particles can be regulated by, for example, changing the firing temperature in synthesis method of the hydroxide containing a metal element other than lithium. For example, the average particle diameter of the primary particles of the first positive electrode active material and the average particle diameter of the second positive electrode active material can be regulated by adjusting the firing temperature within a range from 700 to 1000° C. and a range from 800 to 1100° C., respectively.

The positive electrode 11 may contain another positive electrode active material in addition to the first positive electrode active material and the second positive electrode active material. The percentage by mass of the first positive electrode active material and the second positive electrode active material is preferably, but not limited to, 10 mass % or more and 100 mass % or less, more preferably 20 mass % or more and 100 mass % or less, even more preferably 60 mass % or more and 100 mass % or less, based on the total amount of the positive electrode active material. The additional positive electrode active material other than the first positive electrode active material and the second positive electrode active material is not particularly limited as long as it is a compound that can reversibly intercalate and deintercalate lithium, and examples thereof include compounds having a crystal structure, such as a layered structure, a spinel structure, or an olivine structure, that can intercalate and deintercalate lithium ions while retaining its stable crystal structure.

The positive electrode 11 contains a phosphate compound in the positive electrode mixture layer thereof. The phosphate compound contained in the positive electrode mixture layer is not particularly limited as long as it is a phosphate-containing compound, such as phosphoric acid or a phosphate salt, and examples thereof include lithium phosphate, lithium dihydrogen phosphate, cobalt phosphate, nickel phosphate, manganese phosphate, potassium phosphate, calcium phosphate, sodium phosphate, magnesium phosphate, ammonium phosphate, and ammonium dihydrogen phosphate. These may be used singly or in combinations of two or more thereof. The phosphate compound may be in the form of a hydrate.

Preferable examples of the phosphate compound include lithium phosphate, in view of the formation of a film with good quality. Lithium phosphate may be, for example, trilithium phosphate, lithium dihydrogen phosphate, lithium hydrogen phosphite, lithium monofluorophosphate, or lithium difluorophosphate, and among these, trilithium phosphate (Li₃PO₄) is preferable.

In the positive electrode 11, the phosphate compound may be included in the positive electrode mixture layer thereof, and it is expected that the effect described above is highly exhibited when the phosphate compound is present in the vicinity to the lithium-containing transition metal oxide as the first positive electrode active material. The phosphate compound preferably adheres to the surface of the first positive electrode active material. Specifically, the surface of the particles of the lithium-containing transition metal oxide as the first positive electrode active material is preferably dotted with the phosphate compound adhered thereto.

The ratio of the phosphate compound adheres to the particles of the first positive electrode active material is preferably higher than that to the particles of the second positive electrode active material. In other words, the number of particles of the phosphate compound adhered to a single particle of the first positive electrode active material is preferably larger than that to a single particle of the second positive electrode active material. When such particles of the first positive electrode active material and those of the second positive electrode active material are dispersed in the positive electrode, a much larger amount of the phosphate compound is present in the vicinity of the particles of the first positive electrode active material throughout the positive electrode mixture layer, and it is thus expected that the effect described above is highly exhibited.

The content of the phosphate compound in the positive electrode mixture layer is preferably 0.1 mass % or more and 5 mass % or less, more preferably 0.5 mass % or more and 4 mass % or less, particularly preferably 1 mass % or more and 3 mass % or less, based on the total amount of the first positive electrode active material and the second positive electrode active material (the total amount of the positive electrode active materials including an additional positive electrode active material if contained). When the content of the phosphate compound is within the range described above, a favorable output retention rate at normal temperature after a high-rate cycle test is provided without decrease in the capacity of the positive electrode.

The particle diameter of the phosphate compound is preferably smaller than those of the first positive electrode active material and the second positive electrode active material, and is more preferably, for example, 50 nm or more and 10 μm or less. When the particle diameter of the phosphate compound is within this range, the favorable dispersed state of the phosphate compound in the positive electrode mixture layer is retained. When the phosphate compound is as an agglomerate, the particle diameter of the phosphate compound refers to the particle diameter of the smallest unit of the particles (primary particles) forming the agglomerate. The particle diameter of the phosphate compound is determined as follows: in the observation under a scanning electron microscope (SEM), 100 particles of the phosphate compound are arbitrarily selected: the major axis of each particle is measured; and the average of the found values is determined as the particle diameter of the phosphate compound.

For example, in the production of the positive electrode 11, the positive electrode active materials including the first positive electrode active material and the second positive electrode active material are previously mixed with the phosphate compound mechanically to adhere the phosphate compound to the surface of the particles of the first positive electrode active material. The electrical conductor and the binder are added thereto, if needed, and then a dispersing medium such as water is added thereto to prepare a slurry of a positive electrode mixture.

Moe preferably, the first positive electrode active material is previously mixed with the phosphate compound and the binder mechanically to adhere the phosphate compound to the surface of the particles of the first positive electrode active material. The second positive electrode active material, the electrical conductor, and the binder are added thereto, and then a dispersing medium such as water is added thereto to prepare a slurry of a positive electrode mixture. In this manner, more phosphate compound can be adhered to the first active material than to the second positive electrode active material.

### <Negative Electrode>

The negative electrode 12 includes, for example, a negative collector, such as a metal foil, and a negative electrode mixture layer formed on the negative collector. Foil of a metal, such as copper, that is stable in the electric potential range of the negative electrode 12, a film with such a metal disposed as an outer layer, and the like can be used for the negative collector. The negative electrode mixture layer contains a negative electrode active material and a binder. The negative electrode 12 can be produced by, for example, applying a negative electrode mixture slurry containing the negative electrode active material, the binder, and other components to the negative collector, drying the resulting coating film, and rolling the resulting product to form a negative electrode mixture layer on each side of the collector.

The negative electrode active material is not particularly limited as long as it can reversibly intercalate and deintercalate lithium ions. For example, any of carbon materials such as natural graphite and artificial graphite; and Si and Sn can be used as the negative electrode active material. These may be used singly, or two or more thereof may be mixed and used in combination. Particularly, a carbon material obtained by coating a graphite material with low crystalline carbon is preferably used because a film having a low resistance is likely to form on the surface of the negative electrode.

As the binder used for the negative electrode 12, any known binder can be used, and similarly to the case of the positive electrode 11, a fluorocarbon resin such as PTFE, PAN, a polyimide resin, an acrylic resin, a polyolefin resin, or the like can be used. Examples of the binder used when the negative electrode mixture slurry is prepared using an aqueous solvent include CMC and its salts, styrene-butadiene rubber (SBR), poly(acrylic acid) (PAA) and its salts, and poly(vinyl alcohol) (PVA).

### <Non-Aqueous Electrolyte>

The non-aqueous electrolyte contains a non-aqueous solvent and an electrolyte salt dissolved in the non-aqueous solvent. Example of the non-aqueous solvent used for the non-aqueous electrolyte include esters, ethers, nitriles, amides such as dimethylformamide, and mixed solvents of two or more of these solvents. A halogen-substituted product formed by replacing at least one hydrogen atom of any of the above solvents with a halogen atom such as fluorine may also be used.

Examples of the esters that may be contained in the non-aqueous electrolyte include cyclic carbonate esters, chain carbonate esters, and carboxylate esters. Specifically, examples thereof include cyclic carbonate esters such as ethylene carbonate (EC), propylene carbonate (PC), butylene carbonate, and vinylene carbonate; chain carbonate esters such as dimethyl carbonate (DMC), methyl ethyl carbonate (MEC), diethyl carbonate (DEC), methyl propyl carbonate, ethyl propyl carbonate, and methyl isopropyl carbonate; chain carboxylate esters such as methyl propionate (MP), ethyl propionate, methyl acetate, ethyl acetate, and propyl acetate; and cyclic carboxylate esters such as γ-butyrolactone (GBL) and γ-valerolactone (GVL). Examples includes cyclic carboxylate esters such as γ-butyrolactone (GBL) and γ-valerolactone (GVL).

Examples of the ethers that may contained in the non-aqueous electrolyte include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and chain ethers such as, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles that may contained in the non-aqueous electrolyte include acetonitrile, propionitrile, butyronitrile, valeronitrile, n-heptane nitrile, succinonitrile, glutaronitrile, adiponitrile, pimelonitrile, 1,2,3-propane tricarbonitrile, and 1,3,5-pentane tricarbonitrile.

Examples of the halogen-substituted product that may contained in the non-aqueous electrolyte include a fluorinated cyclic carbonate ester such as 4-fluoroethylene carbonate (FEC), a fluorinated chain carbonate ester, a fluorinated chain carboxylate ester such as methyl 3,3,3-trifluoropropionate (FMP).

The electrolyte salt for the non-aqueous electrolyte is preferably a lithium salt. Examples of the lithium salt include LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CₙF₂ₙ₊₁)ₓ (where 1≤x≤6, and n is 1 or 2), LiB₁₀Cl₁₀, LiC, LiBr, Lil, chloroborane lithium, lithium short-chain aliphatic carboxylates; borate salts such as Li₂B₄O₇, Li(B(C₂O₄)₂), lithium bis(oxalate)borate (LiBOB), and Li(B(C₂O₄)F₂); and imide salts such as LiN(FSO₂)₂ and LiN(CₗF₂ₗ₊₁SO₂)(CₘF₂ₘ₊₁SO₂) (where l and m are integers of 1 or more). These lithium salts may be used singly or in combinations of two or more thereof.

### <Separator>

An ion-permeable and insulating porous sheet is used as the separator 13. Specific examples of the porous sheet include a microporous thin film, woven fabric, and nonwoven fabric. Suitable examples of the material for the separator 13 include olefin resins such as polyethylene and polypropylene, and cellulose. The separator 13 may be a laminate including a cellulose fiber layer and a layer of fibers of a thermoplastic resin such as an olefin resin. The separator 13 may be a multi-layered separator including a polyethylene layer and a polypropylene layer, and a separator a surface of which are coated with a resin such as an aramid resin may also be used as the separator 13.

### EXAMPLES

The present disclosure will now be further described in more details specifically by way of Examples and Comparative Examples, but is not limited to the following Examples.

### Example 1

### [Production of Positive Electrode]

A lamellar lithium transition metal oxide represented by the general formula: Li_{1.054}Ni_{0.199}Co_{0.597}Mn_{0.199}Zr_{0.005}O₂ (first positive electrode active material A1), another lamellar lithium transition metal oxide represented by the general formula: Li_{1.067}Ni_{0.498}Co_{0.199}Mn_{0.299}Zr_{0.005}O₂ (second positive electrode active material B1), and lithium phosphate (Li₃PO₄) were mixed to obtain a positive electrode active material mixture in which the particles of lithium phosphate were adhered to the surface of the particles of first positive electrode active material A1 and those of second positive electrode active material B1. In the mixture, the content of first positive electrode active material A1 was 10 mass % based on the total amount of first positive electrode active material A1 and second positive electrode active material B1. In the mixture, the content of lithium phosphate was 2 mass % f based on the total amount of first positive electrode active material A1 and second positive electrode active material B1.

The 100 nm or less pores volume of first positive electrode active material A1 was 20 mm³/g, and the 100 nm or less pores volume of second positive electrode active material B1 was 2.0 mm³/g, as measured according to the BJH method. The average particle diameter of first positive electrode active material A1 was 8 μm and that of second positive electrode active material B1 was 18 μm, as measured using a laser diffraction/scattering particle diameter distribution analyzer (manufactured by HORIBA, Ltd; the same shall apply hereinafter). First positive electrode active material A1 was found to be secondary particles, which were formed of agglomerated primary particles, and the average particle diameter of the primary particles was 300 nm, as observed under a scanning electron microscope (SEM). Second positive electrode active material B1 was found to be secondary particles, which were formed of agglomerated primary particles, and the average particle diameter of the primary particles was 700 nm, as observed under a SEM.

The above mixture, carbon black (an electrical conductor), and poly(vinylidene fluoride) (PVDF) (a binder) were mixed at a mass ratio of 91:7:2. N-methyl-2-pyrrolidone (NMP) as a dispersing medium was added to the mixture, and the resultant was stirred using a mixer (T.K. HIVIS MIX, manufactured by PRIMIX Corporation) to prepare a positive electrode mixture slurry. Subsequently, the positive electrode mixture slurry was applied to aluminum foil as a positive collector, and the resulting coating film was dried and then rolled with a rolling mill to produce positive electrode C1 having a positive electrode mixture layer formed on each side of the aluminum foil.

When the positive electrode C1 thus obtained was observed under a SEM, it was confirmed that particles of lithium phosphate having an average particle diameter of 100 nm were adhered to the surface of first positive electrode active material A1 and the surface of second positive electrode active material B1. However, apart of lithium phosphate fell off from the surface of the positive electrode active materials in the step of mixing with the electrical conductor and the binder in some cases, resulting in that the part of lithium phosphate that was not adhered to the particles of the positive electrode active materials contained in the positive electrode mixture layer.

### [Production of Negative Electrode]

Graphite powder, carboxymethyl cellulose (CMC), and styrene-butadiene rubber (SBR) were mixed in a mass ratio of 98:1:1. Water was added to the mixture, and the resultant was stirred using a mixer (T.K. HIVIS MIX, manufactured by PRIMIX Corporation) to prepare a negative electrode mixture slurry. Subsequently, the negative electrode mixture slurry was applied to copper foil as a negative collector, and the resulting coating film was dried and then rolled with a rolling mill to prepare a negative electrode having a negative electrode mixture layer formed on each side of the copper foil.

### [Preparation of Non-Aqueous Electrolyte]

Ethylene carbonate (EC), methyl ethyl carbonate (MEC), and dimethyl carbonate (DMC) were mixed in a volume ratio of 30:30:40. LiPF₆ was dissolved in the mixed solvent at a concentration of 1.0 mol/L. Vinylene carbonate was dissolved therein in an amount of 1.0 mass % based on the mixed solvent to prepare a non-aqueous electrolyte.

### [Production of Battery]

An aluminium lead and a nickel lead were attached to the positive electrode C1 and the negative electrode, respectively, and the positive electrode C1 and the negative electrode were spirally wound together with a microporous polyethylene film used as a separator 13 therebetween to produce a wound electrode assembly 14. The electrode assembly 14 was housed in a closed-end cylindrical case body 15, and the above non-aqueous electrolyte was poured thereinto. Then, the opening of the case body 15 was sealed with a gasket 27 and a sealing assembly 16 to produce a non-aqueous electrolyte secondary battery (battery D1) of a cylindrical shape illustrated in FIG. 1.

### Example 2

Positive electrode C2 and battery D2 were produced in the same manner as in Example 1, except that a lamellar lithium transition metal oxide represented by the general formula: Li_{1.054}Ni_{0.199}Co_{0.597}Mn_{0.199}Zr_{0.005}O₂ (first positive electrode active material A2) was used instead of first positive electrode active material A1. The 100 nm or less pores volume of first positive electrode active material A2 was 8.1 mm³/g, as measured according to the BJH method. The average particle diameter of first positive electrode active material A2 was 10 μm as measured using a laser diffraction/scattering particle diameter distribution analyzer. First positive electrode active material A2 was found to be secondary particles, which were formed of agglomerated primary particles, and the average particle diameter of the primary particles was 200 nm, as observed under a SEM. When the positive electrode C2 was observed under a SEM, it was confirmed that particles of lithium phosphate having an average particle diameter of 100 nm were adhered to the surface of first positive electrode active material A2 and the surface of second positive electrode active material B3.

### Example 3

Positive electrode C3 and battery D3 were produced in the same manner as in Example 1, except that a lamellar lithium transition metal oxide represented by the general formula: Li_{1.067}Ni_{0.498}Co_{0.199}Mn_{0.299}Zr_{0.005}O₂ (second positive electrode active material B2) was used instead of second positive electrode active material B1. The 100 nm or less pores volume of second positive electrode active material B2 was 5.0 mm³/g, as measured according to the BJH method. The average particle diameter of second positive electrode active material B2 was 14 μm as measured using a laser diffraction/scattering particle diameter distribution analyzer. Second positive electrode active material B2 was found to be secondary particles, which were formed of agglomerated primary particles, and the average particle diameter of the primary particles was 600 nm, as observed under a SEM. When the positive electrode C3 was observed under a SEM, it was confirmed that particles of lithium phosphate having an average particle diameter of 100 nm were adhered to the surface of first positive electrode active material A1 and the surface of second positive electrode active material B2.

### Example 4

Positive electrode C4 and battery D4 were produced in the same manner as in Example 1, except that the content of first positive electrode active material A1 was changed to 20 mass % based on the total amount of first positive electrode active material A1 and second positive electrode active material B1 when a mixture of first positive electrode active material A1, second positive electrode active material B1, and lithium phosphate was prepared in the process of producing positive electrode C1. When the positive electrode C4 was observed under a SEM, it was confirmed that particles of lithium phosphate having an average particle diameter of 100 nm were adhered to the surface of first positive electrode active material A1 and the surface of second positive electrode active material B1.

### Example 5

Positive electrode C5 and battery D5 were produced in the same manner as in Example 1, except that the content of first positive electrode active material A1 was changed to 30 mass % based on the total amount of first positive electrode active material A1 and second positive electrode active material B1 when a mixture of first positive electrode active material A1, second positive electrode active material B1, and lithium phosphate was prepared in the process of producing positive electrode C1. When the positive electrode C5 was observed under a SEM, it was confirmed that particles of lithium phosphate having an average particle diameter of 100 nm were adhered to the surface of first positive electrode active material A1 and the surface of second positive electrode active material B1.

### Example 6

Positive electrode C6 and battery D6 were produced in the same manner as in Example 1, except that the content of first positive electrode active material A1 was changed to 40 mass % based on the total amount of first positive electrode active material A1 and second positive electrode active material B1 when a mixture of first positive electrode active material A1, second positive electrode active material B1, and lithium phosphate was prepared in the process of producing positive electrode C1. When the positive electrode C6 was observed under a SEM, it was confirmed that particles of lithium phosphate having an average particle diameter of 100 nm were adhered to the surface of first positive electrode active material A1 and the surface of second positive electrode active material B1.

### Comparative Example 1

Positive electrode C7 and battery D7 were produced in the same manner as in Example 1, except that a mixture of first positive electrode active material A1 and second positive electrode active material B1 was prepared without using lithium phosphate in the process of producing positive electrode.

### Comparative Example 2

Positive electrode C8 and battery D8 were produced in the same manner as in Example 1, except that a lamellar lithium transition metal oxide represented by the general formula: Li_{1.054}Ni_{0.199}Co_{0.597}Mn_{0.199}Zr_{0.005}O₂ (first positive electrode active material A3) was used instead of first positive electrode active material A1 and that a lamellar lithium transition metal oxide represented by the general formula: Li_{1.067}Ni_{0.498}Co_{0.199}Mn_{0.299}Zr_{0.005}O₂ (second positive electrode active material B3) was used instead of second positive electrode active material B1. The 100 nm or less pores volume of first positive electrode active material A3 was 6.0 mm³/g, and the 100 nm or less pores volume of second positive electrode active material B3 was 1.2 mm³/g, as measured according to the BJH method. The average particle diameter of first positive electrode active material A3 was 12 μm, and the average particle diameter of second positive electrode active material B3 was 20 μm, as measured using a laser diffraction/scattering particle diameter distribution analyzer. First positive electrode active material A3 was found to be secondary particles, which were formed of agglomerated primary particles, and the average particle diameter of the primary particles was 500 nm, as observed under a SEM. Second positive electrode active material B3 was found to be secondary particles, which were formed of agglomerated primary particles, and the average particle diameter of the primary particles was 800 nm, as observed under a SEM. When the positive electrode C8 was observed under a SEM, it was confirmed that particles of lithium phosphate having an average particle diameter of 100 nm were adhered to the surface of first positive electrode active material A3 and the surface of second positive electrode active material B3.

### Comparative Example 3

Positive electrode C9 and battery D9 were produced in the same manner as in Example 3, except that a lamellar lithium transition metal oxide represented by the general formula: Li_{1.054}Ni_{0.199}Co_{0.597}Mn_{0.199}Zr_{0.005}O₂ (first positive electrode active material A4) was used instead of first positive electrode active material A1. The 100 nm or less pores volume of first positive electrode active material A4 was 16.0 mm³/g, as measured according to the BJH method. The average particle diameter of first positive electrode active material A4 was 9 μm, as measured using a laser diffraction/scattering particle diameter distribution analyzer. First positive electrode active material A4 was found to be secondary particles, which were formed of agglomerated primary particles, and the average particle diameter of the primary particles was 400 nm, as observed under a SEM. When the positive electrode C9 was observed under a SEM, it was confirmed that particles of lithium phosphate having an average particle diameter of 100 nm were adhered to the surface of first positive electrode active material A4 and the surface of second positive electrode active material B2.

### Comparative Example 4

Positive electrode C10 and battery D10 were produced in the same manner as in Example 1, except that a mixture of second positive electrode active material B1 and lithium phosphate was prepared without using first positive electrode active material A1 in the process of producing positive electrode C1, the content of lithium phosphate being 2 mass % based on the amount of second positive electrode active material B1. When the positive electrode C10 was observed under a SEM, it was confirmed that particles of lithium phosphate having an average particle diameter of 100 nm were adhered to the surface of second positive electrode active material B1.

### Comparative Example 5

Positive electrode C11 and battery D11 were produced in the same manner as in Example 1, except that a mixture of first positive electrode active material A1 and lithium phosphate was prepared without second positive electrode active material B1 in the process of producing positive electrode C1, the content of lithium phosphate being 2 mass % based on the amount of first positive electrode active material A1. When the positive electrode C11 was observed under a SEM, it was confirmed that particles of lithium phosphate having an average particle diameter of 100 nm were adhered to the surface of first positive electrode active material A1.

### [Output Characteristics Test]

The rating capacities of batteries D1 to D11 thus produced were determined. A constant current charge of a battery was carried out at a current of 800 mA to 4.1 V at a temperature of 25° C., and then constant voltage charge of the battery was carried out at a voltage of 4.1 V to a current of 0.1 mA. Then, constant current discharge of the battery was carried out at a current of 800 mA to 2.5 V. The discharge capacity in the constant current discharge was taken as the rating capacity of the battery.

The initial outputs at normal temperature of batteries D1 to D11 were determined. A constant current charge of a battery was carried out at a current of 850 mA to 4.1 V at a temperature of 25° C., followed by charging the battery to 50% of the rating capacity thereof at a temperature of 25° C. Then, the maximum current at which discharge could be carried out for 10 seconds to a discharge cutoff voltage of 2.5 V was determined at a battery temperature of 25° C., and the output at normal temperature at a state of charge (SOC) of 50% was calculated from the found maximum current using the following equation: output at normal temperature (SOC 50%)=(found maximum current)×discharge cutoff voltage (2.5 V).

Then, the high-rate cyclic characteristics test was carried out for batteries D1 to D11. 500 charging/discharging cycles were carried out on the battery at a temperature of 60° C., a single charging/discharging cycle consisting of a constant current charge of a battery at a current of 1700 mA to 4.1 V, a quiescent period of 15 minutes, a constant current discharge of a battery at a current of 1700 mA to 2.5 V, and another quiescent period of 15 minutes. After the 500 charging/discharging cycles, the output at normal temperature after the high-rate cyclic characteristics test was determined in the same manner for the initial outputs at normal temperature.

For each battery D1 to D11, the ratio (percentage) of the output at normal temperature after a high-rate cyclic characteristics test to the initial output at normal temperature was calculated, which was taken as the output retention rate at normal temperature. The cyclic characteristics of each battery were evaluated on the basis of the output retention rate at normal temperature.

In Table 1, shown are the 100 nm or less pores volume and the average particle diameter of the primary particles of each of the first positive electrode active material and the second positive electrode active material, the first/second pore volume ratio, the presence or absence of lithium phosphate, the content of the first positive electrode active material based on the total amount of the first positive electrode active material and the second positive electrode active material, and the output retention rate at normal temperature calculated from the initial output at normal temperature and the output at normal temperature after a high-rate cyclic characteristics test, for each battery.

TABLE 1

| | | First positive electrode | | | Second positive electrode | | | | | Content of | Output |
|---|---|---|---|---|---|---|---|---|---|---|---|
| | | active material | | | active material | | | | | first positive | retention |
| | | | 100 nm or | Average particle | | 100 nm or | Average particle | | | electrode | rate |
| | | | less pores | diameter of | | less pores | diameter of | First/second | | active | at normal |
| | Battery | | volume | primary particles | | volume | primary particles | pore volume | Lithium | material | temperature |
| | No. | No. | (mm³/g) | (nm) | No. | (mm³/g) | (nm) | ratio | phosphate | (%) | (%) |
| Example 1 | D1 | A1 | 20 | 300 | B1 | 2 | 700 | 10 | yes | 10 | 93 |
| Example 2 | D2 | A2 | 8.1 | 200 | B1 | 2 | 700 | 4.05 | yes | 10 | 92 |
| Example 3 | D3 | A1 | 20 | 300 | B2 | 5 | 600 | 4 | yes | 10 | 93 |
| Example 4 | D4 | A1 | 20 | 300 | B1 | 2 | 700 | 10 | yes | 20 | 93 |
| Example 5 | D5 | A1 | 20 | 300 | B1 | 2 | 700 | 10 | yes | 30 | 98 |
| Example 6 | D6 | A1 | 20 | 300 | B1 | 2 | 700 | 10 | yes | 40 | 91 |
| Comparative | D7 | A1 | 20 | 300 | B1 | 2 | 700 | 10 | | 10 | 86 |
| Example 1 | | | | | | | | | | | |
| Comparative | D8 | A3 | 6 | 500 | B3 | 1.2 | 800 | 5 | yes | 10 | 86 |
| Example 2 | | | | | | | | | | | |
| Comparative | D9 | A4 | 16 | 400 | B2 | 5 | 600 | 3.2 | yes | 10 | 85 |
| Example 3 | | | | | | | | | | | |
| Comparative | D10 | — | — | — | B1 | 2 | 700 | — | yes | 0 | 88 |
| Example 4 | | | | | | | | | | | |
| Comparative | D11 | A1 | 20 | 300 | — | — | — | — | yes | 100 | 63 |
| Example 5 | | | | | | | | | | | |

As clear from the results shown in Table 1, batteries D1 to D6 had a remarkably excellent output retention rate at normal temperature after a high-rate cyclic characteristics test compared to batteries D7 to D11, batteries D1 to D6 being prepared by using the positive electrodes C1 to C6, respectively, which contained a first positive electrode active material having a 100 nm or less pores volume of 8 mm³/g ore, a second positive electrode active material having a 100 nm or less pores volume of 5 mm³/g or less, and phosphate compound, and had a first/second pore volume ratio of 4 or more. Thus, it was confirmed that the positive electrode 11 for a non-aqueous electrolyte secondary battery, which contains a first positive electrode active material having a 100 nm or less pores volume of 8 mm³/g or more, a second positive electrode active material having a 100 nm or less pores volume of 5 mm³/g or less, and phosphate compound, and had a first/second pore volume ratio of 4 or more, can improve the output retention rate at normal temperature after a high-rate cyclic characteristics test of a non-aqueous electrolyte secondary battery 10.

Among batteries D1 and D4 to D6, batteries D1. D4, and D5, which had a content of the first positive electrode active material of 30 mass % or less based on the total amount of the first positive electrode active material and the second positive electrode active material, had a more favorable output retention rate at normal temperature than battery D6, which had a content of the first positive electrode active material of 40 mass % based on the total amount of the first positive electrode active material and the second positive electrode active material.

### REFERENCE SIGNS LIST

10 non-aqueous electrolyte secondary battery
11 positive electrode
12 negative electrode
13 separator
14 electrode assembly
15 case body
16 sealing assembly
17 insulating plate
18 insulating plate
19 positive electrode lead
20 negative electrode lead
21 projecting portion
22 filter
22a opening
23 lower vent member
24 insulating member
25 upper vent member
26 cap
26a opening
27 gasket

1. A positive electrode for a non-aqueous electrolyte secondary battery, comprising a first positive electrode active material, a second positive electrode active material, and a phosphate compound, wherein
the first positive electrode active material has a pore volume, of pores each having a pore diameter of 100 nm or less, per mass of 8 mm³/g or more,
the second positive electrode active material has a pore volume, of pores each having a pore diameter of 100 nm or less, per mass of 5 mm³/g or less, and
the pore volume, of pores each having a pore diameter of 100 nm or less, per mass of the first positive electrode active material is 4 or more times the pore volume, of pores each having a pore diameter of 100 nm or less, per mass of the second positive electrode active material.

2. The positive electrode for a non-aqueous electrolyte secondary battery according to claim 1, wherein the content of the first positive electrode active material is 30 mass % or less based on the total amount of the first positive electrode active material and the second positive electrode active material.

3. The positive electrode for a non-aqueous electrolyte secondary battery according to claim 1, wherein both the first positive electrode active material and the second positive electrode active material are in the form of secondary particles, and
an average particle diameter of primary particles constituting the first positive electrode active material is 500 nm or less, and is smaller than an average particle diameter of primary particles constituting the second positive electrode active material.

4. The positive electrode for a non-aqueous electrolyte secondary battery according to claim 1, wherein both the first positive electrode active material and the second positive electrode active material are lamellar lithium transition metal oxide represented by a general formula: Li₁₊ₓMₐO_{2+b}, wherein x, a, and b meet conditions: a=1, −0.2≤x≤0.4, and −0.1≤b≤0.4, and M represents metal elements including at least one element selected from the group consisting of Ni, Co, Mn, and Al.
